(19) United States
(12) Patent Application Publication
(10) Pub. No.: US 2026/0201252 A1
(43) Pub. Date: Jul. 16, 2026

(54) NANOEMULSIONS OF PLANT BASED JELLY

(71) Applicant: Conopco, Inc., d/b/a UNILEVER, Hoboken, NJ (US)

(72) Inventors: Bivash Ranjan DASGUPTA, Cheshire, CT (US); Gabriella Satchi Olivia FREY, Milford, CT (US); Jamie Lynn MILLER, North Haven, CT (US); Teanoosh MOADDEL, Watertown, CT (US); Congling QUAN, Woodbridge, CT (US)

(73) Assignee: Conopco, Inc., d/b/a UNILEVER, Hoboken, NJ (US)

(21) Appl. No.: 19/135,057

(22) PCT Filed: Nov. 23, 2023
(86) PCT No.: PCT/EP2023/082813

§ 371 Date: Jun. 2, 2025

Related U.S. Application Data
(60) Provisional application No. 63/430,941, filed on Dec. 7, 2022.

(30) Foreign Application Priority Data
Mar. 3, 2023 (EP) 23159990.3

(51) Int. Cl. C09K 23/34

(52) U.S. Cl. CPC C09K 23/34

(57) ABSTRACT

A nanoemulsion composition comprises an internal oil phase, comprising: 40 to 75% by weight of the total nanoemulsion composition of a plant-based jelly comprising hydrogenated plant-based oils having a melting point of 20 to 80° C., blends of plant-based liquid oil and naturally derived wax, plant-based butter, oligomers synthesized from plant-based compositions, or a combination thereof; and optionally a C8 to C18, preferably C10 to C14 fatty acid, wherein, when the fatty acid is present, the plant-based jelly and fatty acid are in a ratio of 120:1 to 2:1, preferably 20:1 to 2:1, more preferably, 9:1 to 2:1; and an external aqueous phase, comprising: water; and 1.6 to 15% by weight of the total nanoemulsion composition of a surfactant or surfactants comprising an alkali metal, an ammonium salt of acyl isethionate, an alkali metal C1 to C3 alkyl acyl taurate, an acyl taurate, a zwitterionic surfactant, an amphoteric surfactant, or a combination thereof; wherein the surfactant or surfactants comprising an alkali metal, an ammonium salt of acyl isethionate, an alkali metal C1 to C3 alkyl acyl taurate, an acyl taurate, or a combination thereof comprises equal to 70% or greater of all surfactants present in the external aqueous phase of the nanoemulsion.

### FIELD OF THE INVENTION

Disclosed herein are nanoemulsion compositions comprising plant-based jelly and methods of making thereof. Plant-based jellies can be classified for use in the nanoemulsions. The nanoemulsion compositions include an internal oil phase comprising the plant-based jelly and optionally a fatty acid and an external aqueous phase.

### BACKGROUND OF THE INVENTION

Nanoemulsions are becoming increasingly popular for use in personal care compositions. They are stable and have a high surface area in view of their unit volume.

Nanoemulsions can also carry actives in their water and oil phases and are desirable since they enhance penetration of actives through the skin as well as topical benefits delivered to consumers that employ end use compositions formulated with the same. Nanoemulsions not only result in better active penetration, but they also improve the therapeutic impact and overall sensory benefits appreciated by consumers when compared to compositions formulated without them.

It is therefore of increasing interest to develop nanoemulsions that result in excellent benefits to consumers after topical application.

Petrolatum jelly, a product of the petrochemical industry, has been used in cosmetic products either as leave-on or rinse-off, providing excellent moisturization effect, due to its high occlusivity. In recent years, plant-based ingredients have become increasingly popular in the cosmetic industry for sustainability purposes. As a result, petrolatum jelly is being replaced by plant-based jelly in more and more cosmetic products. Petrolatum-free products that seek to serve as a substitute for petrolatum-based products like petrolatum jelly may have a drawback of not having the same consistency or feel to the user in application as the petrolatum-based products. For example, petrolatum-free oil-based products which may be used as an alternative to petrolatum jelly may have lower viscosity than conventional petrolatum jelly, or the oil base may have been processed, e.g., by hydrogenation of the oil component, to provide a hydrogenated oil component having a thicker consistency than its non-hydrogenated counterpart.

Oil-in-water (o/w) nanoemulsions of petrolatum jelly have been developed for skin cleansing formulations to increase the deposition of petrolatum jelly onto human skin for increased moisturization effects. With an increasing demand for naturally sourced moisturizers to replace petrolatum jelly, it is desired to prepare nanoemulsions of plant-based jellies for cleansing formulations.

Accordingly, it is continually desired to produce cleansing products containing nanoemulsions with more sustainable ingredients with respect to the environment than traditionally known products, such as petrolatum jelly.

### SUMMARY OF THE INVENTION

Disclosed in various aspects are nanoemulsion compositions and methods of making thereof.

A method of classifying plant-based jelly for nanoemulsions comprises: providing a plant-based jelly; combining the plant-based jelly with a C8 to C18, preferably C10 to C14 fatty acid, to form a mixture, wherein the plant-based jelly and fatty acid are in a ratio of 30:1 to 2:1, preferably 20:1 to 2:1; more preferably 10:1 to 2:1, even more preferably, 9:1 to 2:1; heating the mixture until it reaches a molten state or less than or equal to 85° C.; cooling the mixture to room temperature; subjecting the mixture to a heating and cooling cycle, wherein the heating and cooling cycle comprises heating from a temperature range of −80° C. to −40° C. to a temperature range of 80° C. to 120° C., preferably heating from a temperature range of −70° C. to −60° C. to a temperature range of 90° C. to 110° C. and then cooling from a temperature of 80° C. to 120° C. to a temperature range of −80° C. to −40° C., preferably cooling from a temperature of 90° C. to 110° C. to a temperature range of −70° C. to −60° C. In an embodiment, the heating and cooling cycle comprises heating from a temperature of −60° C. to 100° C. and then cooling from a temperature of 100° C. to −60° C., preferably heating from a temperature of −50° C. to 100° C. and then cooling from a temperature of 100° C. to −50° C., more preferably heating from a temperature of −40° C. to 100° C. and then cooling from a temperature of 100° C. to −40° C. The heating and cooling rate is 1° C. per minute to 15° C. per minute, preferably 2° C. per minute to 12° C. per minute, more preferably 3° C. per minute to 10° C. per minute, even more preferably 10° C. per minute. The method also comprises analyzing the mixture with a differential scanning calorimeter; selecting the plant-based jelly for the nanoemulsion if the area under the fatty acid induced peak on the cooling profile is greater than 2.5 Joules/gram, preferably greater than or equal to 2.75 Joules/gram.

A nanoemulsion composition comprises an internal oil phase, comprising: 40 to 75% by weight of the total nanoemulsion composition of a plant-based jelly comprising hydrogenated plant-based oils having a melting point of 20 to 80° C., blends of plant-based liquid oil and naturally derived wax, plant-based butter, oligomers synthesized from plant-based compositions, or a combination thereof; and optionally a C8 to C18, preferably C10 to C14 fatty acid, wherein, when the fatty acid is present, the plant-based jelly and fatty acid are in a ratio of 120:1 to 2:1, preferably 20:1 to 2:1, more preferably, 9:1 to 2:1; and an external aqueous phase, comprising: water; and 1.6 to 15% by weight of the total nanoemulsion composition of a surfactant or surfactants comprising an alkali metal, an ammonium salt of acyl isethionate, an alkali metal C1 to C3 alkyl alkyl taurate, an acyl taurate, a zwitterionic surfactant, an amphoteric surfactant, or a combination thereof; wherein the surfactant or surfactants comprising an alkali metal, an ammonium salt of acyl isethionate, an alkali metal C1 to C3 alkyl, alkyl taurate, or a combination thereof comprises equal to 70% or greater of all surfactants present in the external aqueous phase of the nanoemulsion.

These and other features and characteristics are more particularly described below.

### DETAILED DESCRIPTION OF THE INVENTION

Disclosed herein is a method of classifying plant-based jelly for use in nanoemulsion compositions, methods of making the nanoemulsion compositions, and nanoemulsion compositions. The method of classifying plant-based jelly for nanoemulsions comprises first providing a plant-based jelly, then combining the plant-based jelly with a C8 to C18, preferably a C10 to C14 fatty acid, to form a mixture. The plant-based jelly and fatty acid can be present in the nanoemulsion compositions in a ratio of 30:1 to 2:1, preferably 20:1 to 2:1, more preferably, 10:1 to 2:1, even more preferably, 9:1 to 2:1. For example, the plant-based jelly to fatty acid ratio can be 7.5:1 to 2:1, for example, 5:1 to 2:1. The mixture can then be heated until it reaches a molten state. Molten state generally refers to something that has been reduced to a liquid form by heating. Generally, the mixture can be heated to a temperature of 40 to 95° C., for example, 50° C. to 85° C., for example, 60 to 80° C., for example, 65 to 75° C. to achieve the molten state, for example, less than or equal to 85° C. The mixture can then be cooled to room temperature. As referred to herein, room temperature generally refers to a temperature of 20° C. (72° F.). After cooling to room temperature, the mixture can be subjected to a heating and cooling cycle. The heating and cooling cycle can comprise wherein the heating and cooling cycle comprises heating from a temperature range of −80° C. to −40° C. to a temperature range of 80° C. to 120° C., preferably heating from a temperature range of −70° C. to −60° C. to a temperature range of 90° C. to 110° C. and then cooling from a temperature of 80° C. to 120° C. to a temperature range of −80° C. to −40° C., preferably cooling from a temperature of 90° C. to 110° C. to a temperature range of −70° C. to −60° C. In an embodiment, the heating and cooling cycle comprises heating from a temperature of −60° C. to 100° C. and then cooling from a temperature of 100° C. to −60° C., preferably heating from a temperature of −50° C. to 100° C. and then cooling from a temperature of 100° C. to −50° C., more preferably heating from a temperature of −40° C. to 100° C. and then cooling from a temperature of 100° C. to −40° C. The heating and cooling cycle can have a rate of 1° C. per minute to 15° C. per minute, preferably 2° C. per minute to 12° C. per minute, more preferably 3° C. per minute to 10° C. per minute, even more preferably 10° C. per minute. In an embodiment, the heating and cooling cycle has a rate of 10° C. per minute. After the heating and cooling cycle, the mixture can be analyzed with a differential scanning calorimeter where if a size of the area under the fatty acid induced peak on the cooling profile is greater than 2.5 Joules/gram (J/g), preferably greater than or equal to 2.75 J/g, then the plant-based jelly can be selected to form a nanoemulsion. For example, a size of the peak can be greater than or equal to 3.0 J/g.

Also disclosed herein is a nanoemulsion composition. The nanoemulsion composition comprises an internal oil phase and an external aqueous phase.

The internal oil phase comprises the plant-based jelly and optionally a C₈ to C₂₂, preferably a C₁₀ to C₁₄ fatty acid, wherein, when the fatty acid is present, the plant-based jelly and fatty acid are present in the internal oil phase in a ratio of 120:1; preferably 20:1, more preferably, 9:1. For example, the ratio of plant-based jelly to fatty acid can be 120:1 to 2:1, for example, 100:1 to 2:1, for example, 75:1 to 2:1, for example, 50:1 to 2:1, for example, 25:1 to 2:1, for example, 20:1 to 2:1, for example, 15:1 to 2:1, for example, 10:1 to 2:1, for example, 9:1 to 2:1, for example, 7.5:1 to 2:1, for example, 5:1 to 2:1. The internal oil phase can comprise 40 to 75% by weight of total nanoemulsion composition of the plant-based jelly. For example, the plant-based jelly can be present in an amount of 40 to 75% by weight of the total nanoemulsion composition, for example, 50 to 70% by weight, for example, 55 to 65% by weight, for example, 60% by weight of the plant-based jelly based on the total nanoemulsion composition, including any and all ranges and values subsumed therein.

The plant-based jellies can comprise hydrogenated plant-based oils with a melting point of 20° C. to 80° C., blends of plant-based liquid oil and naturally derived wax, plant-based butter, oligomerized plant-based compositions, or a combination thereof.

The hydrogenated plant-based oils with a melting point of 20° C. to 80° C. can be formed via addition of hydrogen atoms to the unsaturated bonds, such as double bonds, on the carbon chains of plant oils. The hydrogenated plant-based oils can be fully or partially hydrogenated, where the level of hydrogenation can be 1 to 100%, with 100% being fully hydrogenated. When all the unsaturated bonds become saturated, the plant-based oils become fully hydrogenated (i.e., 100% hydrogenated); when a portion of the unsaturated bonds become saturated, the plant-based oils become partially hydrogenated. The more unsaturated bonds that become saturated, the higher the melting point of the plant-based oils. The plant-based oils comprise triglycerides, such as soybean oil, sunflower seed oil, palm oil, olive oil, canola oil, jatropha oil, argan oil, castor oil, etc., and mono-ester oil, such as jojoba oil.

The blends of the plant-based oil and naturally derived wax can comprise (a) 25-95% by wt. of a pre-blended mixture composition of naturally derived hydrocarbon liquids comprising (1) squalene or other plant derived C15-23 alkanes; (2) mono-esters; (3) triglycerides or (4) a combination thereof; the oily liquids have a melting or phase transition point of less than 30° C. and a viscosity of 500 Pascal-seconds (Pa·s) or less at room temperature; and (b) 5 to 75% by wt. of a pre-blended mixture composition of a naturally derived structuring material comprising naturally derived plant and vegetable waxes; esters of naturally derived long chain (C16 to C34) fatty acids and long chain (C16 to C34) fatty alcohols; or a combination thereof, wherein the structuring material has melting point of greater than 30° C.

The plant-based butter can comprise shea butter, mango seed butter, olive butter, hemp seed butter, almond butter, cocoa butter, coconut butter, macadamia butter, kokum butter, babassu butter, moringa butter, jojoba butter, sunflower seed butter, or a combination thereof.

The oligomerized plant-based compositions are oligomers containing 2 to 30 repeating units of triglycerides, esters, and terpenes etc., synthesized via various polymerization methods from plant-based compositions, fatty acids, fatty alcohols, or polyols. Hydrogenation or esterification can be carried out to tune the oligomerized plant oils. Naturally derived waxes can be added into these oligomers to adjust their thermal behavior or their texture. Examples of oligomerized oils include polycitronellol (Citropol H) and polycitronellol acetate (Citropol 1A) available from P2 Science, Inc.; hydrogenated soy polyglycerides available from Elevance Renewable Science, which is a polymerized soybean oil via self-metathesis followed by hydrogenation; BOTANIJELLY™ available from Cargill, made by esterification and polymerization of natural oils (e.g., BOTANIJELLY™ 105) (hydrogenated vegetable glyceride); CETIOL® SoftFeel available from BASF, which is C12-18 Alkanoyl Glycerin/Sebacic Acid Copolymer (e.g., CETIOL® SB45; butyrospermum parkii (shea) butter); Estolides or Estolide esters, a class of oligomers of unsaturated fatty acids (e.g. oleic acid) or hydroxy fatty acids (e.g., 12-hydroxy stearic acid), with secondary ester linkages on the alkyl backbone, e.g., BIOESTOLIDE™ 1300 from Biosythetic Technologies, which is Acetyl Ethylhexyl Polyhydroxystearate. PELEMOL DISD available from Phoenix Chemical, which is the diester formed by the reaction of isosteryl alcohol and dimer dilinoleic acid to form Diisostearyl Dimer Dilinoleate.

The plant-based jellies can comprise a combination of any of the described plant-based jellies. For example, the plant-based jelly can comprise a combination of castor wax (e.g., castor wax MP-70 which is hydrogenated castor oil, castor oil, and trihydroxystearin) from ACME-Hardesty and soybean oil in a ratio of 1:20 to 20:1, for example, 1:15 to 15:1, for example, 2:10 to 10:2, for example, 2:7 to 7:2, for example, 3:6 to 6:3. In another example, the plant-based jelly can comprise a combination of hydrogenated vegetable glycerides (e.g., castor wax MP-70 which is hydrogenated castor oil, castor oil, and trihydroxystearin) from ACME-Hardesty and castor oil in a ratio of 1:20 to 20:1, for example, 1:15 to 15:1, for example, 2:10 to 10:2, for example, 2:7 to 7:2, for example, 3:6 to 6:3. In another example, the plant-based jelly can comprise hydrogenated vegetable glyceride (e.g., BOTANIJELLY™ 105 from Cargill Company). In another example, the plant-based jelly can comprise a combination of hydrogenated vegetable glyceride (e.g., BOTANIJELLY™ 105 from Cargill Company) and moringa oil (available from Naturex) in a ratio of 20:1 to 1:20, for example, 15:1 to 1:15, for example, 10:1 to 1:10, for example, 9:1 to 1:9, for example, 2:8 to 8:2, for example 3:7 to 7:3. In yet another example, the plant-based jelly can comprise a combination of hydrogenated vegetable glyceride (e.g., BOTANIJELLY™ 105 from Cargill Company) and Vitamin E Acetate in a ratio of 20:1 to 1:20, for example, 15:1 to 1:15, for example, 10:1 to 1:10, for example, 9:1 to 1:9, for example, 2:8 to 8:2, for example 3:7 to 7:3. In another example, the plant-based jelly can comprise a combination of polycitronellol and euphorbia cerifera (candelilla) wax, e.g., commercially available from P2 Science Inc. as CITROLATUM™ C. In another embodiment, the plant-based jelly can comprise jojoba ester, e.g., commercially available from Floratech as FLORAESTER™ 30. In another example, the plant-based jelly can comprise a combination of butyrospermum parkii (shea) butter (e.g., CETIOL® SB 45 available from BASF) and hydrogenated castor oil in a ratio of 20:1 to 1:20, for example, 15:1 to 1:15, for example, 10:1 to 1:10, for example, 8:1 to 1:8, for example, 2:7 to 7:2, for example, 3:6 to 6:3. In another example, the plant-based jelly can comprise a combination of butyrospermum parkii (shea) butter (e.g., CETIOL® SB 45 available from BASF) and trihydroxystearin in a ratio of 20:1 to 1:20, for example, 15:1 to 1:15, for example, 10:1 to 1:10, for example, 8:1 to 1:8, for example, 2:7 to 7:2, for example, 3:6 to 6:3. In another example, the plant-based jelly can comprise a combination of moringa butter (e.g., available from Hall) and phytantriol (e.g., available from DSM) in a ratio of 1:20 to 20:1, for example, 1:10 to 10:1, for example, 1:9 to 9:1, for example, 1:8 to 8:1, for example, 1:5 to 5:1.

All of the above-mentioned plant-based jellies and various combinations are preferred embodiments of the present nanoemulsions.

The external aqueous phase comprises water and a surfactant or surfactants. The surfactant can preferably comprise an alkali metal, an ammonium salt of acyl isethionate, an acyl taurate, an alkali metal C1 to C3 alkyl acyl taurate, a zwitterionic surfactant, an amphoteric surfactant, or a combination thereof. These alkali metal, ammonium salt of acyl isethionate, alkali metal C1 to C3 alkyl taurate, and acyl surfactants can comprise 70% or greater of all surfactants present in the external aqueous phase of the nanoemulsion. The surfactant can be present in an amount of 1.0 to 20% by weight of the total nanoemulsion composition, for example, 1.6 to 15% by weight of the total nanoemulsion composition. For example, the surfactant can be present in an amount of 2.0 to 15% by weight, for example, 4.0 to 14% by weight, for example, 5.0 to 13% by weight, for example, 6.0 to 12% by weight, for example, 7.5 to 10% by weight surfactant of the total nanoemulsion composition, including any and all ranges and values subsumed therein.

Due to the diverse nature of plant-based jelly, it can be challenging to prepare nanoemulsions. For example, there can be issues associated with phase inversion when attempting to form coarse emulsions, gelling, or phase separation after nanoemulsions are formed, or even too high of a process temperature, e.g., greater than or equal to 90° C., required for natural jellies containing high melting point waxes. High temperature can cause product discoloration, excessive evaporation of the aqueous phase and difficulty in maintaining such temperature with conventional emulsion processing equipment.

Unexpectedly, it was discovered that fatty acids can be used as a screening tool to identify which plant-based jellies could be made into stable nanoemulsions. The fatty acid can be an optional component of the nanoemulsion composition meaning that it is not necessarily present in the nanoemulsion composition. When present in the nanoemulsion composition, the fatty acid can depress the melting or freezing point of the plant-based jelly containing a high melting point wax, thereby making it possible to prepare a nanoemulsion of such plant-based jelly within normal processing temperatures, for example, less than or equal to 75° C. or below.

The optional fatty acid can comprise lauric acid, myristic acid, palmitic acid, stearic acid, coconut fatty acid, isostearic acid, or a combination thereof. Preferably, the fatty acid is lauric acid.

When present, the fatty acid can be present in an amount of 0.1 to 15% by weight, for example, 0.2 to 12% by weight, for example, 0.25 to 10% by weight, for example, 0.3 to 9% by weight, for example, 0.3 to 8.4% by weight, for example, 0.4 to 7% by weight, for example, 0.5 to 0.65% by weight, based on the total weight of the nanoemulsion composition, including any and all ranges and values subsumed therein.

A blend of 90% by weight of plant-based jelly and 10% by weight of fatty acid can be used to characterize the plant-based jelly for use in nanoemulsion compositions using a differential scanning calorimeter. It was unexpectedly found that the fatty acid induces an exothermic peak during the cooling process at temperatures of 100° C. to −40° C. The heating and cooling rate can be 1° C. per minute to 15° C. per minute, preferably 2° C. per minute to 12° C. per minute, more preferably 3° C. per minute to 10° C. per minute, even more preferably 10° C. per minute. When the size of the area under the peak is greater than 2.5 J/g, preferably, greater than or equal to 2.75 J/g, more preferably greater than or equal to 3.0 J/g, the plant-based jelly was able to produce a stable nanoemulsion. However, if the size of the area under the peak was less than 2.5 J/g or no fatty acid induced peak was detected, then a stable nanoemulsion of the plant-based jelly was not able to be produced.

It was further unexpectedly found that when the fatty acid was present in the plant-based jelly and the natural jelly contained high melting point waxes, the presence of the fatty acid can help reduce the melting point and the freezing point of the oil phase of the plant-based jelly by 1 to 20° C., for example, 3 to 15° C. Reduction of the melting point and the freezing point can reduce the storage temperature of the molten oil phase before use for nanoemulsions and can also reduce the processing temperature of the nanoemulsion compositions by 10 to 15° C., e.g., from 100° C. to 85° C., for example, 90° C. to 75° C.

Methods of making the nanoemulsion are also contemplated. An exemplary method includes providing a plant-based jelly and classifying the plant-based jelly according to the method as disclosed herein. If the plant-based jelly meets the criteria, i.e., the size of the area under the peak is greater than 2.5 J/g, preferably, greater than or equal to 2.75 J/g, more preferably greater than or equal to 3.0 J/g, then then plant-based jelly can be used to form the nanoemulsion. In the method, an internal oil phase comprising the plant-based jelly is heated to a temperature of greater than or equal to 55° C., for example, 65° C. to 100° C., for example, 65 to 75° C. and an external aqueous phase comprising water and a surfactant is heated to a temperature of greater than or equal to 55° C., for example, 65° C. to 100° C., for example, 65 to 75° C. After heating, the internal oil phase and the external aqueous phase are combined to form a first emulsion in a conventional emulsion processing equipment system. The first emulsion is then passed through a high pressure device, such as a high pressure sonolator at a pressure of greater than or equal to 1000 pounds per square inch (psi) (6.9 MegaPascals (MPa), for example, 1500 to 5000 psi (10.3 to 34.5 MPa) to form the nanoemulsion, for example, 1500 to 4500 psi (10.3 to 31 MPa), for example, 2000 to 4000 psi (13.8 to 27.6 MPa). Generally, sonolators can operate as pressures of 100 to 5000 psi (0.7 to 34.5 MPa). For pressures above 500 psi 3.4 MPa, the sonolator can be referred to as a high pressure sonolator. When formed, the nanoemulsion comprises droplets having a volume average diameter size (D[4,3]) of nanometers (nm) to 750 nm, for example, 60 nm to 500 nm, for example, 75 nm to 350 nm, in terms of volume average diameter, D[4,3], including any and all ranges and values subsumed therein.

Within the nanoemulsion, the plant-based jelly generally is present in an amount of 40% to 80%, and preferably, 40% to 75%, and most preferably, from 50 to 65% by weight of the nanoemulsion, including any and all ranges and values subsumed therein.

An optional ingredient which may be used in the internal oil phase is an oil phase stabilizer. For example, small amounts (e.g., 0.0002 to 2%, preferably 0.0005 to 1.5%, more preferably, 0.0005-1% by weight of the nanoemulsion) of antioxidant may be used. For example, exemplary antioxidants can be butylated hydroxytoluene (BHT), tocopherol (vitamin E), ascorbic acid (vitamin C), or a combination thereof.

As to the C₈ to C₁₈ fatty acids that can be used with the plant-based jelly described herein, the same may be branched or linear, saturated, or unsaturated. Caprylic, lauric, myristic, palmitic, stearic, behenic acid, coconut fatty acid, or a combination thereof are often preferred saturated linear fatty acids. Preferred branched fatty acids include isostearic acid, isopalmitic acid, 17-methylstearic acid, 15-methylpalmitic acid, or a combination thereof.

The unsaturated fatty acids desirable for use include palmitoleic acid, oleic acid, petroselinic acid, linoleic acid, erucic acid, nervonic acid, conjugated linoleic acid, or a combination thereof. It is within the scope of the present nanoemulsions to utilize a mixture of the aforementioned fatty acids. Especially when the end use composition is a leave-on care composition, longer chain fatty acids such as stearic acid, isostearic acid, or a combination thereof can be used in the nanoemulsion. Shorter chain fatty acids such as lauric acid, myristic acid, or a combination thereof can be preferred especially when the end use composition is a wash off composition.

When included, fatty acid can be present in an amount of 0.1 to 10.0% by weight, for example, 0.3 to 8.3% by weight, for example, 0.5 to 8.0% by weight, for example, 0.75 to 7.5% by weight, for example, 1.0 to 7.0% by weight, for example, 1.5 to 6.0% by weight, for example, 2.0 to 5.5% by weight, for example, 3 to 5% by weight of the nanoemulsion, including any and all ranges and values subsumed therein. In an embodiment, the weight ratio of plant-based jelly to fatty acid can be 120:1 to 2:1, for example, 100:1 to 2:1, for example, 75:1 to 2:1, for example, 50:1 to 2:1, for example, 25:1 to 2:1, for example, 20:1 to 2:1, for example, 15:1 to 2:1, for example, 10:1 to 2:1, for example, 9:1 to 2:1, for example, 7.5:1 to 2:1, for example, 5:1 to 2:1, the ratio of plant-based jelly to fatty acid can be 120:1 to 2:1, for example, 100:1 to 2:1, for example, 75:1 to 2:1, for example, 50:1 to 2:1, for example, 25:1 to 2:1, for example, 20:1 to 2:1, for example, 15:1 to 2:1, for example, 10:1 to 2:1, for example, 9:1 to 2:1, for example, 7.5:1 to 2:1, for example, 5:1 to 2:1.

It is within the scope of the present nanoemulsions and end use compositions thereof to optionally include, within the internal oil phase comprising plant-based jelly and fatty acid or the internal oil phase comprising plant-based jelly, oil soluble benefit actives like hydroxystearic acid (e.g., 10-hydroxystearic acid, 12-hydroxystearic acid, etc.) (including an ester thereof), vitamins A, D, E, or K (and their oil soluble derivatives), vitamin E acetate, sunscreens like octocrylene, octisalate (ethylhexyl salicylate), homosalate (3,3,5-trimethylcyclohexyl salicylate), ethylhexylmethoxycinnamate, 2-ethylhexyl-2-hydroxybenzoate, drometriazole trisiloxane, bis-ethyl hexyloxyphenol methoxyphenol triazine, 2-ethylhexyl-2-cyano-3,3-diphenyl-2-propanoic acid, 3,3,5-trimethyl cyclohexyl 2-hydroxybenzoate, 2-ethylhexyl-2-hydroxybenzoate, or a combination thereof.

Other optional oil soluble benefit agents suitable for use include resorcinols like 4-hexyl resorcinol, 4-phenylethyl resorcinol, 4-cyclopentyl resorcinol, 4-cyclohexyl resorcinol 4-isopropyl resorcinol, or a combination thereof. Also, 5-substituted resorcinols like 4-cyclohexyl-5-methylbenzene-1,3-diol, 4-isopropyl-5-methylbenzene-1,3-diol, or a combination thereof or the like may be used. The 5-substituted resorcinols, and their synthesis are described in U.S. Pat. No. 10,470,986.

Even other oil soluble actives suitable for use include omega-3 fatty acids, omega-6 fatty acids, climbazole, farnesol, ursolic acid, myristic acid, geranyl geraniol, oleyl betaine, cocoyl hydroxyethyl imidazoline, hexanoyl sphingosine, 12-hydroxystearic acid, petroselinic acid, conjugated linoleic acid, terpineol, thymol, or a combination thereof.

In an embodiment, the oil soluble benefit active can be a retinoic acid precursor represented by the formula:

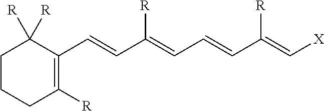

where each R is independently a hydrogen or a C₁₋₆ alkyl group and X is any of the structures listed below

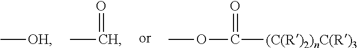

and further where each R′ is hydrogen or a C1-C3 alkyl and n is an integer from 0 to 16 (preferably, 1 to 5).

The optional oil soluble benefit agent can be a retinoic acid precursor. The retinoic acid precursor can be retinol, retinal, retinyl propionate, retinyl palmitate, retinyl acetate, or a combination thereof. Retinyl propionate, retinyl palmitate, or a combination thereof can be typically preferred.

Still another retinoic acid precursor is hydroxyanasatil retinoate made commercially available under the name RETEXTRA® as supplied by Molecular Design International. The same may be used in a mixture with the oil soluble actives described herein.

When used, the oil soluble benefit agent can be present in an amount of 0.001 to 12% by weight, preferably, 0.01 to 8% by weight, more preferably, 0.1 to 6% by weight of the nanoemulsion, including any and all ranges and values subsumed therein.

Neutralizer desirable for use to neutralize the fatty acid in the present nanoemulsion is limited to the extent that the same may be used in a topical composition and is able to neutralize up to 100% by weight of the fatty acid within the nanoemulsion. Preferred neutralizers include sodium hydroxide (NaOH), potassium hydroxide (KOH), triethanolamine, or a combination thereof. It is within the scope of the present nanoemulsions to add, with or in lieu of fatty acid and neutralizer, fatty acid soap, and fatty acid soap with additional neutralizer.

As to the amount of neutralizer employed to make the nanoemulsions, the same is adjusted so that 10 to 100%, and preferably, 20 to 85%, and most preferably, 35 to 65% by weight of all fatty acid within the nanoemulsion is neutralized. To the extent neutralization of the fatty acid exceeds 70%, it is especially preferred that less than 55%, and most preferably, less than 50% by weight of the total neutralizer used is NaOH when the fatty acid used is saturated, linear, and C16 or greater.

In another preferred embodiment, if fatty acid neutralization is to exceed 70% with NaOH as the neutralizer, it is preferred that more than 45%, and preferably, more than 50% by weight of the fatty acid used to make the nanoemulsion is branched and saturated, and/or linear and unsaturated.

Optionally, additional anionic and amphoteric surfactants can be used when preparing the nanoemulsion. When present, the nanoemulsion comprises less than 6% by weight, and preferably, 0.001 to 4% by weight of the additional surfactants.

The surfactant in the external aqueous phase or optional additional surfactant can be selected from an anionic surfactant, a zwitterionic surfactant, an amphoteric surfactant, or a combination thereof. The surfactant can contain C₈-C₁₈ alkyl groups, for example, C₁₂-C₁₆ alkyl groups, for example, C₁₀-C₁₄ alkyl groups, or mixtures thereof. For example, the surfactant can contain Cao alkyl groups, C₁₂ alkyl groups, C₁₄ alkyl groups, or any combination thereof.

When present, the anionic surfactant used can include aliphatic sulfonates, such as a primary alkane (e.g., C₈-C₂₂) sulfonate, primary alkane (e.g., C₈-C₂₂) disulfonate, C₈-C₂₂ alkene sulfonate, C₈-C₂₂ hydroxyalkane sulfonate or alkyl glyceryl ether sulfonate (AGS); or aromatic sulfonates such as alkyl benzene sulfonate. The anionic surfactant may also be an alkyl sulfate (e.g., C₁₂-C₁₈ alkyl sulfate) or alkyl ether sulfate (including alkyl glyceryl ether sulfates). Among the alkyl ether sulfates are those having the formula:

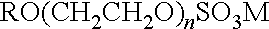

wherein R is an alkyl or alkenyl having 8 to 18 carbons, preferably 12 to 18 carbons, n has an average value of at least 1.0, preferably less than 5, and most preferably 1 to 4, and M is a solubilizing cation such as sodium, potassium, ammonium or substituted ammonium.

The anionic surfactant may also be alkyl sulfosuccinates (including mono- and dialkyl, e.g., C₆-C₂₂ sulfosuccinates); alkyl and acyl taurates (often methyl taurates), alkyl and acyl sarcosinates, sulfoacetates, C₈-C₂₂ alkyl phosphates and phosphonates, alkyl phosphate esters and alkoxyl alkyl phosphate esters, acyl lactates, C₈-C₂₂ monoalkyl succinates and maleates, sulphoacetates, alkyl glucosides and acyl isethionates, and the like.

Sulfosuccinates may be monoalkyl sulfosuccinates having the formula:

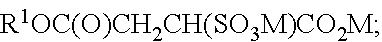

and amide-MEA sulfosuccinates of the formula:

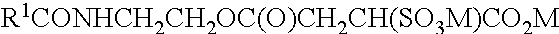

wherein R¹ ranges from C₈-C₂₂ alkyl.

Sarcosinates are generally indicated by the formula:
R²CON(CH₃)CH₂CO₂M, wherein R² ranges from C₈-C₂₀ alkyl.

Taurates are generally identified by formula:

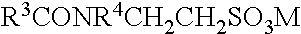

wherein R³ is a C₈-C₂₀ alkyl, R⁴ is a C₁-C₄ alkyl.

M is a solubilizing cation as previously described.

The nanoemulsion disclosed herein can contain C₈-C₁₈ acyl isethionates. These esters are prepared by a reaction between alkali metal isethionate with mixed aliphatic fatty acids having from 6 to 18 carbon atoms and an iodine value of less than 20. At least 75% of the mixed fatty acids have from 12 to 18 carbon atoms and up to 25% have from 6 to 10 carbon atoms.

The acyl isethionate may be an alkoxylated isethionate such as is described in Ilardi et al., U.S. Pat. No. 5,393,466, entitled “Fatty Acid Esters of Polyalkoxylated isethonic acid; issued Feb. 28, 1995; hereby incorporated by reference. This compound has the general formula:

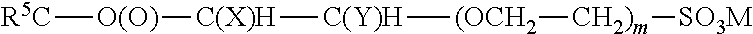

wherein R⁵ is an alkyl group having 8 to 18 carbons, m is an integer from 1 to 4, X and Y are each independently hydrogen or an alkyl group having 1 to 4 carbons and M is a solubilizing cation as previously described.

In an aspect, the anionic surfactant used is 2-acrylamido-2-methylpropane sulfonic acid, ammonium lauryl sulfate, ammonium perfluorononanoate, potassium lauryl sulfate, sodium alkyl sulfate, sodium dodecyl sulfate, sodium laurate, sodium laureth sulfate, sodium lauroyl sarcosinate, sodium stearate, sodium sulfosuccinate esters, sodium lauroyl isethionate, or a combination thereof. Such anionic surfactants are commercially available from suppliers like Galaxy Surfactants, Clariant, Sino Lion, Stepan Company, and Innospec.

Amphoteric surfactants (which depending on pH can be zwitterionic) include sodium acyl amphoacetates, sodium acyl amphopropionates, disodium acyl amphodiacetates and disodium acyl amphodipropionates where the acyl (i.e., alkanoyl group) can comprise a C₇-C₁₈ alkyl portion. Illustrative examples of amphoteric surfactants include sodium lauroamphoacetate, sodium cocoamphoacetate, or a combination thereof.

As to the zwitterionic surfactants employed, such surfactants include at least one acid group. Such an acid group may be a carboxylic or a sulphonic acid group. They often include quaternary nitrogen, and therefore, can be quaternary amino acids. They should generally include an alkyl or alkenyl group of 7 to 18 carbon atoms and generally comply with an overall structural formula:

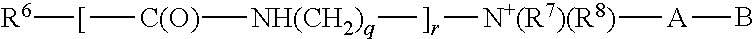

where R⁸ is alkyl or alkenyl of 7 to 18 carbon atoms; R⁷ and R⁸ are each independently alkyl, hydroxyalkyl or carboxyalkyl of 1 to 3 carbon atoms; q is 2 to 4; r is 0 to 1; A is alkylene of 1 to 3 carbon atoms optionally substituted with hydroxyl, and B is —CO₂— or —SO₃—.

Desirable zwitterionic surfactants include simple betaines of formula:

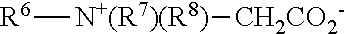

and amido betaines of formula:

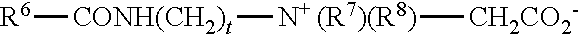

where t is 2 or 3.

In both formulae R⁶, R⁷ and R⁸ are as defined previously. R⁶ may, in particular, be a mixture of C₁₂ and C₁₄ alkyl groups derived from coconut oil so that at least half, preferably at least three quarters of the groups R⁶ have 10 to 14 carbon atoms. R⁷ and R⁸ are preferably methyl.

A further possibility is that the zwitterionic surfactant is a sulphobetaine of formula:

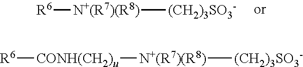

where u is 2 or 3, or variants of these in which —(CH₂)₃SO₃⁻ is replaced by —CH₂C(OH)(H)CH₂SO₃⁻.

In these formulae, R⁶, R⁷ and R⁸ are as previously defined.

Illustrative examples of the zwitterionic surfactants desirable for use include betaines such as lauryl betaine, betaine citrate, cocodimethyl carboxymethyl betaine, cocoamidopropyl betaine, coco alkyldimethyl betaine, and laurylamidopropyl betaine. An additional zwitterionic surfactant suitable for use includes cocoamidopropyl sultaine, for example, cocamidopropyl hydroxysultaine. Preferred zwitterionic surfactants include lauryl betaine, betaine citrate, sodium hydroxymethylglycinate, (carboxymethyl) dimethyl-3-[(1-oxododecyl) amino]propylammonium hydroxide, coco alkyldimethyl betaine, (carboxymethyl) dimethyloleylammonium hydroxide, cocoamidopropyl betaine, (carboxymethyl) dimethyloleylammonium hydroxide, cocoamidopropyl betaine, (carboxylatomethyl) dimethyl(octadecyl)ammonium, cocamidopropyl hydroxysultaine, or a combination thereof. Such surfactants are made commercially available from suppliers like Stepan Company, Solvay, Evonik and the like and it is within the scope of the nanoemulsions disclosed herein to employ mixtures of the aforementioned surfactants.

Nonionic surfactants may optionally be used in the external aqueous phase of the nanoemulsion. When used, nonionic surfactants are typically used at levels as low as 0.5, 1, 1.5 or 2% by weight and at levels as high as 6, 8, 10 or 12% by weight of the total nanoemulsion composition, including any and all ranges and values subsumed therein. The nonionic surfactants which may be used include in particular the reaction products of compounds having a hydrophobic group and a reactive hydrogen atom, for example aliphatic alcohols, acids, amides or alkylphenols with alkylene oxides, especially ethylene oxide either alone or with propylene oxide. Specific nonionic surfactant compounds are alkyl (C₆-C₂₂) phenols, ethylene oxide condensates, the condensation products of aliphatic (C₈-C₁₈) primary or secondary linear or branched alcohols with ethylene oxide, and products made by condensation of ethylene oxide with the reaction products of propylene oxide and ethylenediamine. Other nonionic surfactants include long chain tertiary amine oxides, long chain tertiary phosphine oxides, dialkyl sulphoxides, and the like.

In an aspect, nonionic surfactants can include fatty acid/alcohol ethoxylates having the following structures a) HOCH₂(CH₂)ₛ(CH₂CH₂O)_{c} H or b) HOOC(CH₂)ᵥ(CH₂CH₂O)_{d} H; where s and v are each independently an integer up to 18; and c and d are each independently an integer from 1 or greater. In an aspect, s and v can be each independently 6 to 18; and c and d can be each independently 1 to 30. Other options for nonionic surfactants include those having the formula HOOC(CH₂)ᵢ—CH═CH—(CH₂)ₖ(CH₂CH₂O)_{z} H, where i, k are each independently 5 to 15; and z is 5 to 50. In another aspect, i and k are each independently 6 to 12; and z is 15 to 35.

The nonionic surfactant can also include a sugar amide, such as a polysaccharide amide. Specifically, the surfactant can be one of the lactobionamides described in U.S. Pat. No. 5,389,279 to Au et al., entitled “Compositions Comprising Nonionic Glycolipid Surfactants issued Feb. 14, 1995; which is hereby incorporated by reference or it may be one of the sugar amides described in U.S. Pat. No. 5,009,814 to Kelkenberg, titled “Use of N-Poly Hydroxyalkyl Fatty Acid Amides as Thickening Agents for Liquid Aqueous Surfactant Systems” issued Apr. 23, 1991; hereby incorporated into the subject application by reference.

Illustrative examples of nonionic surfactants that can optionally be used in the cleansing compositions disclosed herein include, but are not limited to, polyglycoside, cetyl alcohol, decyl glucoside, lauryl glucoside, octaethylene glycol monododecyl ether, n-octyl beta-d-thioglucopyranoside, octyl glucoside, oleyl alcohol, polysorbate, sorbitan, stearyl alcohol, or a combination thereof.

In an aspect, cationic surfactants may optionally be used in the nanoemulsion of the present application.

One class of cationic surfactants includes heterocyclic ammonium salts such as cetyl or stearyl pyridinium chloride, alkyl amidoethyl pyrrylinodium methyl sulfate, and lapyrium chloride.

Tetra alkyl ammonium salts are another useful class of cationic surfactants for use. Examples include cetyl or stearyl trimethyl ammonium chloride or bromide; hydrogenated palm or tallow trimethylammonium halides; behenyl trimethyl ammonium halides or methyl sulfates; decyl isononyl dimethyl ammonium halides; ditallow (or distearyl) dimethyl ammonium halides, and behenyl dimethyl ammonium chloride.

Still other types of cationic surfactants that may be used are the various ethoxylated quaternary amines and ester quats. Examples include PEG-5 stearyl ammonium lactate (e.g., Genamin KSL manufactured by Clariant), PEG-2 coco ammonium chloride, PEG-15 hydrogenated tallow ammonium chloride, PEG 15 stearyl ammonium chloride, dipalmitoyl ethyl methyl ammonium chloride, dipalmitoyl hydroxyethyl methyl sulfate, and stearyl amidopropyl dimethylamine lactate.

Still other useful cationic surfactants include quaternized hydrolysates of silk, wheat, and keratin proteins, and it is within the scope of the cleansing composition to use mixtures of the aforementioned cationic surfactants.

If used, cationic surfactants will make up no more than 1.0% by weight of the total weight of the nanoemulsion. When present, cationic surfactants typically make up from 0.01 to 0.7%, and more typically, from 0.1 to 0.5% by weight of the total weight of the nanoemulsion, including any and all ranges subsumed therein.

Preferred anionic surfactants which may be used include sodium acyl isethionate, sodium acyl methyl isethionate, sodium methyl cocoyl taurate, sodium trideceth sulphate, sodium lauryl ether sulfate-3EO, acylglutamate, acylglycinate, lauroyl sarcosinate, acyl sarcosinate or mixtures thereof. Optional amphoteric surfactants suitable for use such include coco betaine, cocamidopropyl betaine, sodium lauroamphoacetate, lauramidopropyl hydroxysultaine, cocamidopropyl hydroxysultaine, or a combination thereof.

In a preferred embodiment a water miscible liquid is not used in the aqueous phase. Preferably, water makes up at least 25%, by weight, of the external aqueous phase, preferably at least 50%, even more preferably at least 75% of the external aqueous phase, by weight of the external aqueous phase.

In a preferred embodiment, the external aqueous phase comprises water and a water miscible liquid. Preferably, the water miscible liquid makes up 5 to 75% by weight of the aqueous phase.

In another preferred embodiment, the external aqueous phase comprises water and a surfactant, where the surfactant comprises 1.5 to 15% by weight of the total weight of the nanoemulsion.

As to the external aqueous phase (water; water and water miscible liquid mixed therewith; water and surfactant; water, surfactant, and water miscible liquid mixed therewith), the same typically makes up 20 to 55% by weight, and preferably, from 25 to 45% by weight, and most preferably, from 30 to 40% by weight of the total weight of the nanoemulsion.

Preferred water miscible liquids include those classified as humectants like glycerol, sorbitol, hydroxypropyl sorbitol, hexyleneglycol, 1,3-butylene glycol, 1,2,6-hexanetriol, ethoxylated glycerine, propoxylated glycerine, or mixtures thereof.

For example, the water miscible liquid used can be glycerol. Typically, the water miscible liquid to water weight ratio is from 1:3 to 3:1, and preferably, 1:2.5 to 2.5:1, and most preferably, 1.5:1 to 1:1.5, including all ratios subsumed therein.

It is within the scope to include water soluble actives within the aqueous phase of the nanoemulsion. Such water soluble actives are limited only to the extent that they can be used in topical compositions. Illustrative examples of the water soluble actives that may be used in this invention include niacinamide, picolinamide, ascorbic acid, salicylic acid, dihydroxyacetone, extracts, like pomegranate extract, vitamins, like Vitamin C, as well as sunscreens such as the salts of benzophenone-4 and phenylbenzimidazole sulfonic acid. Mixtures and water soluble derivatives of the same may also be used. Typically, when used in the nanoemulsion, water soluble active makes up from 0.0 to 6%, and preferably, from 0.001 to 5%, and most preferably, from 0.01 to 4%, based on total weight of the nanoemulsion and including any and all ranges subsumed therein.

When manufacturing the nanoemulsion, ingredients are first mixed (i.e., oil phase to water phase, or water phase to oil phase or simultaneously) in a conventional mixing vessel equipped with a rotor/stator high shear device to produce a macroemulsion. The high shear mixing device used, which may be in line or within the mixing vessel, is commercially available from suppliers like ESCO-LABOR AG and Silverson®. The macroemulsion produced typically has a volume average droplet diameter size (D[4,3]) of less than 8 micrometers, and preferably, less than 5 micrometers, and most preferably, less than 2 micrometers as measured with an art recognized Malvern Mastersizer. Rotor speed is often 1,000 to 8,000 revolutions per minute (rpm), and preferably, 2,000 to 7,500 rpm, and most preferably, 3,000 to 7,000 rpm. The time required to homogeneously mix the ingredients is the time for a theoretical pass minimum, yielding the desired homogeneous macroemulsion.

Alternatively, the macroemulsion may be made in a continuous mode, by supplying the internal oil phase and external aqueous phase simultaneously into a low pressure homogenizer (e.g., low pressure sonolator), typically operating at 100 to less than 500 pounds per square inch (psi) (0.7 MPa to 3.45 MPa), made commercially available from Sonic Corporation of Connecticut, USA).

The macroemulsion prepared is then passed through a device, e.g., a high pressure device, i.e., a high pressure homogenizer to form the desired nanoemulsion. The high pressure homogenizers suitable for use are the art recognized devices that may be operated at 600 to 7000 psi (4.14 to 48.3 MPa), and preferably, from 900 to 6000 psi (6.2 to 41.4), and most preferably, from 1000 to 5500 psi (6.89 to 37.9 MPa) to produce the nanoemulsion. Those made commercially available from BEE International, Massachusetts, USA (manufacturer of DeBee series homogenizers) and Sonic Corporation of Connecticut, USA (manufacturer of high pressure sonolators) are suitable for use.

When water miscible liquid is included in the water (external aqueous) phase and fatty acid is included in the oil phase, high pressure homogenization is not required to produce the nanoemulsion of the aforementioned diameter sizes. Therefore, a nanoemulsion of desired diameter is produced after mixing solely with a commercially available rotor/stator device (or low pressure homogenizer) under the conditions described above with respect to the low pressure homogenizer, e.g., typically operating at 100 to less than 500 pounds per square inch (psi) (0.689 MPa to 3.45 MPa).

In an embodiment, a water miscible liquid makes up from 25 to 75% by weight of the water miscible phase and the nanoemulsion is produced without homogenization that exceeds 500 psi (3.45 MPa).

In an embodiment, an aqueous phase with water soluble components and an internal oil phase with oil soluble components are each first mixed and prepared prior to mixing all ingredients with a high shear mixing device. If a phase is unclear and/or not homogeneous, it is within the scope to separately heat each phase to a temperature of 30 to 85° C., and preferably, 40 to 80° C., and most preferably, 45 to 75° C. until a homogeneous solution or mixture is obtained.

The pH of the resulting nanoemulsions is typically 5 to 10, and preferably, 6.5 to 8.5, including any and all ranges and values subsumed therein.

The nanoemulsions can be used as end use compositions, and therefore, applied topically to hair and/or skin directly by consumers. It is also within the scope of the present nanoemulsions to add the nanoemulsion to a commercially available end use product to boost the efficacy of such end use product.

Since the nanoemulsions are water continuous, it is preferred that the end use composition used with the nanoemulsion is also water continuous.

When a nanoemulsion is not the end use composition, the consumer will be instructed to mix the nanoemulsion and end use composition (leave-on or wash off) in his or her hands until a homogeneous mixture is made. Upon obtaining a homogeneous mixture, product may then be topically applied. In a most preferred embodiment and when a nanoemulsion and end use composition are mixed, 2 to 50% by weight, and preferably, 5 to 35% by weight, and most preferably, 10 to 25% by weight nanoemulsion is used based on total weight of nanoemulsion and end use composition, including any and all ranges and values subsumed therein.

Since water is present, traditional preservatives found in topical consumer products may be used. The preservatives typically make up from 0.01 to 3% by weight of the total weight of the nanoemulsion, for example, 0.01 to 2.0% by weight of the total weight of the nanoemulsion, including any and all ranges and values subsumed therein. Preservatives can desirably be incorporated into the concentrated cleansing composition to protect against the growth of potentially harmful microorganisms. Cosmetic chemists are familiar with appropriate preservatives and routinely choose them to satisfy the preservative challenge test and to provide product stability.

Preservatives for use include hydantoin derivatives and propionate salts. Particularly preferred preservatives are include iodopropynyl butyl carbamate, phenoxyethanol, 1,2-alkane diols, hydroxyacetophenone, ethylhexylglycerine, hexylene glycol, methyl paraben, propyl paraben, benzyl alcohol, benzoic acid, potassium sorbate, iodopropynyl butyl carbamate, caprylyl glycol (CAPG), 1,2-octanediol, hydroxyacetophenone, ethylhexylglycerine, hexylene glycol, methyl paraben, propyl paraben, imidazolidinyl urea, sodium dehydroacetate, dimethyl-dimethyl (DMDM) hydantoin, or a combination thereof. Other preservatives include sodium dehydroacetate, chlorophenesin, decylene glycol, or a combination thereof. The preservatives should be selected having regard for the use of the composition and possible incompatibilities between the preservatives and other ingredients in the nanoemulsion. Preservatives are preferably employed in amounts ranging from 0.01% to 2.0% by weight of the total weight of the end use composition (up to 7% by weight of total concentrated cleansing composition), including any and all ranges subsumed therein. Preservatives include sodium benzoate, benzoic acid, potassium sorbate, or a combination thereof.

Fragrances, fixatives, opacifiers (like titanium dioxide or glycol distearate), and chelating agents can optionally be included in the nanoemulsion. Possible chelating agents include, but are not limited to, ethylyene diaminetetraacetic acid (EDTA), diethylenetriaminepentaacetic acid (DTPA), ethylene diamine disuccinic acid (EDDS), pentasodium diethylenetriaminepentaacetate, trisodium N-(hydroxyethyl)-ethylenediaminetracetate, an acid form of EDTA, sodium thiocyanate, trisodium salt of methylglycinediacetic acid, tetrasodium glutamate diacetate and phytic acid, preferably wherein the chelating agent is ethylene diaminetetraacetic acid (EDTA), diethylenetriaminepentaacetic acid (DTPA), ethylene diamine disuccinic acid (EDDS), or a combination thereof. Each of these substances may be present in an amount of 0.03 to 5%, preferably 0.05 to 0.09% by weight of the total weight of the nanoemulsion, including any and all ranges and values subsumed therein.

Emulsifiers having an HLB of greater than 8 may optionally be used. Illustrative examples include Tween 40, 60, 80, polysorbate 20, or a combination thereof. Typically, emulsifiers for water continuous systems make up from 0.3 to 2.5% by weight of the total weight of the nanoemulsion.

Humectants can be employed as additives in the nanoemulsion to assist in moisturization when such emulsions are topically applied. These are generally polyhydric alcohol type materials. Typical polyhydric alcohols include glycerol (i.e., glycerine or glycerin), propylene glycol, dipropylene glycol, polypropylene glycol (e.g., PPG-9), polyethylene glycol, sorbitol, hydroxypropyl sorbitol, hexylene glycol, 1,3-butylene glycol, isoprene glycol, 1,2,6-hexanetriol, ethoxylated glycerol, propoxylated glycerol, or a combination thereof. Most preferred is glycerin, propylene glycol, dipropylene glycol, or a combination thereof. In an embodiment, the humectant can be propylene glycol, butylene glycol, dipropylene glycol, glycerin, triethylene glycol, erythritol, capryl glycol, hyaluronic acid, or a combination thereof.

Often, humectant makes up from 0.0 to 35%, and preferably, 0.001 to 20% by weight, more preferably, 0.5 to 15% by weight (most preferably, 0.75 to 12% by weight) of the total weight of the nanoemulsion, including any and all ranges and values subsumed therein.

Thickening agents are optionally suitable for use in the nanoemulsion. Particularly useful are polysaccharides. Examples include fibers, starches, natural/synthetic gums, and cellulosics. Representative of the starches are chemically modified starches such as sodium hydroxypropyl starch phosphate, and aluminum starch octenylsuccinate. Tapioca starch is often preferred, as is maltodextrin. Suitable gums include xanthan, sclerotium, pectin, karaya, arabic, agar, guar (including Acacia senegal guar), carrageenan, alginate, or a combination thereof. Suitable cellulosics include hydroxypropyl cellulose, hydroxypropyl methylcellulose, ethylcellulose, sodium carboxy methylcellulose (cellulose gum/carboxymethyl cellulose), and cellulose (e.g., cellulose microfibrils, cellulose nanocrystals or microcrystalline cellulose). Sources of cellulose microfibrils include secondary cell wall materials (e.g., wood pulp, cotton), bacterial cellulose, and primary cell wall materials. Preferably the source of primary cell wall material is selected from parenchymal tissue from fruits, roots, bulbs, tubers, seeds, leaves, and combination thereof; more preferably is selected from citrus fruit, tomato fruit, peach fruit, pumpkin fruit, kiwi fruit, apple fruit, mango fruit, sugar beet, beet root, turnip, parsnip, maize, oat, wheat, peas, and combinations thereof; and even more preferably is selected from citrus fruit, tomato fruit, and combinations thereof. A most preferred source of primary cell wall material is parenchymal tissue from citrus fruit. Citrus fibers, such as those made available by HERBACEL® as AQ Plus can also be used as source for cellulose microfibrils. The cellulose sources can be surface modified by any of the known methods including those described in Colloidal Polymer Science, Kalia et al., “Nanofibrillated cellulose: surface modification and potential applications” (2014), Vol 292, Pages 5-31.

Synthetic polymers, in addition to polymeric viscosity aids, are yet another class of effective thickening agents that can optionally be used. This category includes crosslinked polyacrylates such as the Carbomers, polyacrylamides such as SEPIGEL® 305 and taurate copolymers such as SIMULGEL® EG and ARISTOFLEX® AVC, the copolymers being identified by respective INCI nomenclature as sodium acrylate/sodium acryloyldimethyl taurate and acryloyl dimethyltaurate/vinyl pyrrolidone copolymer. Another preferred synthetic polymer suitable for thickening is an acrylate-based polymer made commercially available by Seppic and sold under the name SIMULGEL™ INS100. Calcium carbonate, fumed silica, and magnesium-aluminum-silicate can also be used.

Carbomer can also be used as a suspending agent. Carbomer can be present in an amount of 0.1 to 0.5% by weight, based on the total weight of the cleansing composition, for example, 0.2 to 0.4% by weight.

The amounts of optional thickening agent, when used, may range from 0.001 to 5% by weight of the compositions. Maltodextrin, xanthan gum, and carboxymethyl cellulose are the often preferred optional thickening agents. In an embodiment, the thickening agent can comprise sodium chloride, silica, bentonite, magnesium aluminium silicate, carbomer, cellulose, or a combination thereof.

Droplets of the nanoemulsions as disclosed herein, typically have volume average diameter size (D[4,3]) (also used interchangeably in and with terms “volume mean diameter” or “volume average size”) of 750 nm or less, preferably 60 nm to 500 nm, more preferably 75 to 350 nm.

Nanoemulsions with droplet sizes in these ranges can be obtained using a device, such as a high pressure homogenizer, for example, a high pressure sonolator. Pressures used can be 5000 psi or less, preferably 4500 psi or less (34.5 MPa or less, 31 MPa or less).

A wide variety of packaging may be employed to store and deliver the nanoemulsion. Packaging is often dependent upon the type of personal care end-use. For instance, leave-on skin lotions and creams, shampoos, conditioners and shower gels generally employ plastic containers with an opening at a dispensing end covered by a closure. Typical closures are screwcaps, non-aerosol pumps and flip-top hinged lids. Packaging for antiperspirants, deodorants and depilatories may involve a container with a roll-on ball on a dispensing end. Alternatively, these types of personal care products may be delivered in a composition formulation in a container with a propel/repel mechanism. Metallic cans pressurized by a propellant and having a spray nozzle serve as packaging for antiperspirants, shave creams and other personal care products.

Skin, as used herein, is meant to include skin on the arms (including underarms), face, feet, neck, chest, hands, legs, buttocks and scalp (including hair). End use composition (water or oil continuous but preferably water continuous) is a composition for topical application and includes a cream, lotion, balm, serum, gel, mousse, aerosol, deodorant, antiperspirant, shampoo, conditioner, make-up and personal wash, including bars and liquids. Such an end use composition can be the nanoemulsion or nanoemulsion added to an end use composition. Benefit active is an oil soluble component that delivers a benefit to skin after being topically applied. Oil, as used herein, is meant to include a substance that has a melting point below 75° C., including oils which are benefit actives like sunscreens. High pressure, as defined herein, means 600 psi or more, and preferably, over 850 psi. In an embodiment, the end use composition is water continuous as is the nanoemulsion of this invention. In another embodiment, the end use composition is a leave-on skin lotion or cream, or a solid or liquid personal wash composition.

Viscosity, as used herein, is taken with a Discovery HR-2 Rheometer using sand blasted plates having a 1000 micron gap and a first shear rate S_{A} of 0.4 s⁻¹ for a first viscosity V_{A} and a second shear rate S_{B} of 10 s⁻¹ for a second viscosity V_{B}, both at 25° C. and 20 second intervals.

Except where otherwise explicitly indicated, all numbers in this description indicating amounts of material or conditions of reaction, physical properties of materials and/or use are to be understood as modified by the word “about.” All amounts are by weight of the final composition, unless otherwise specified.

It should be noted that in specifying any range of concentration or amount, any particular upper concentration can be associated with any particular lower concentration or amount as well as any subranges consumed therein. In that regard, it is noted that all ranges disclosed herein are inclusive of the endpoints, and the endpoints are independently combinable with each other (e.g., ranges of “up to 25% by weight, or, more specifically, 5% by weight to 20% by weight, in inclusive of the endpoints and all intermediate values of the ranges of 5% by weight to 25% by weight, etc.). “Combination is inclusive of blends, mixtures, alloys, reaction products, and the like. Furthermore, the terms “first,” “second,” and the like herein do not denote any order, quantity, or importance, but rather are used to distinguish one element from another. The terms “a” and “an” and “the” herein do not denote a limitation of quantity and are to be construed to cover both the singular and the plural, unless otherwise indicated herein or clearly contradicted by context. The suffix “(s)” as used herein is intended to include both the singular and the plural of the term it modifies, thereby including one or more of the term (e.g., the film(s) includes one or more films). Reference throughout the specification to “one embodiment”, “one aspect”, “another embodiment”, “another aspect”, “an embodiment”, “an aspect” and so forth means that a particular element (e.g., feature, structure, and/or characteristic) described in connection with the embodiment or aspect is included in at least one embodiment or aspect described herein and may or may not be present in other embodiments or aspects. In addition, it is to be understood that the described elements may be combined in any suitable manner in the various embodiments or aspects.

All cited patents, patent applications, and other references are incorporated herein by reference in their entirety. However, if a term in the present application contradicts or conflicts with a term in the incorporated reference, the term from the present application takes precedence over the conflicting term from the incorporated reference. While particular aspects have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications, variations, improvements, and substantial equivalents.

For the avoidance of doubt the word “comprising” is intended to mean “including” but not necessarily “consisting of” or “composed of.” In other words, the listed steps, options, or alternatives need not be exhaustive.

The disclosure of the invention as found herein is to be considered to cover all aspects as found in the claims as being multiply dependent upon each other irrespective of the fact that claims may be found without multiple dependency or redundancy. Unless otherwise specified, numerical ranges expressed in the format “from x to y” are understood to include x and y. In specifying any range of values or amounts, any particular upper value or amount can be associated with any particular lower value or amount. All percentages and ratios contained herein are calculated by weight unless otherwise indicated. The various features of the present invention referred to in individual sections above apply, as appropriate, to other sections mutatis mutandis. Consequently, features specified in one section may be combined with features specified in other sections as appropriate. Any section headings are added for convenience only and are not intended to limit the disclosure in any way.

### FIGURES

The following is a brief description of the figures wherein like elements are numbered alike and which are presented for the purposes of illustrating the exemplary embodiments disclosed herein and not for the purposes of limiting the same.

FIG. 1 is a graphical representation of the heat flow versus temperature for a plant-based jelly comprising fatty acid and for a plant-based jelly not comprising fatty acid.

FIG. 2 is a graphical representation of the heat flow versus temperature for a plant-based jelly comprising fatty acid and for a plant-based jelly not comprising fatty acid.

FIG. 3 is a graphical representation of the heat flow versus temperature for a plant-based jelly comprising fatty acid and for a plant-based jelly not comprising fatty acid.

FIG. 4 is a graphical representation of the heat flow versus temperature for a plant-based jelly comprising fatty acid and for a plant-based jelly not comprising fatty acid.

FIG. 5 is a graphical representation of the heat flow versus temperature for a plant-based jelly comprising fatty acid and for a plant-based jelly not comprising fatty acid.

FIG. 6 is a graphical representation of the heat flow versus temperature for a plant-based jelly comprising fatty acid and for a plant-based jelly not comprising fatty acid.

FIG. 7 is a graphical representation of the heat flow versus temperature for a plant-based jelly comprising fatty acid and for a plant-based jelly not comprising fatty acid.

FIG. 8 is a graphical representation of the heat flow versus temperature for a plant-based jelly comprising fatty acid and for a plant-based jelly not comprising fatty acid.

FIG. 9 is a graphical representation of the heat flow versus temperature for a plant-based jelly comprising fatty acid and for a plant-based jelly not comprising fatty acid.

FIG. 10 is a graphical representation of the heat flow versus temperature for a plant-based jelly comprising fatty acid and for a plant-based jelly not comprising fatty acid.

FIG. 11 is a graphical representation of the heat flow versus temperature for a plant-based jelly comprising fatty acid and for a plant-based jelly not comprising fatty acid.

### EXAMPLES

The following examples are merely illustrative of the method of classifying plant-based jellies and nanoemulsion compositions disclosed herein and are not intended to limit the scope hereof.

Preparation of Plant-Based Jellies with and without Fatty Acid

Various plant-based jellies were provided or prepared for classification through DSC analysis and preparation of nanoemulsions. Table 1 lists the commercially available and prepared plant-based jellies that were used in the DSC characterization.

TABLE 1
List of Natural Jellies for DSC analysis
and the preparation of nanoemulsions

| Plant-based | |
|---|---|
| Jelly # | Description of Natural Jelly |
| #1 | Castor wax MP 70¹/Soybean oil blend (2/7) |
| #2 | CETIOL ® SB 45⁸/Hydrogenated castor oil¹ blend (8/1) |
| #3 | CETIOL ® SB 45⁸/Trihydroxystearin¹ blend (8/1) |
| #4 | BOTANIJELLY ™ 105² |
| #5 | BOTANIJELLY ™ 105²/Moringa Oil⁵ blend (9/1) |
| #6 | FLORAESTER ™ 30³ |
| #7 | CITROLATUM ™ C⁴ |
| #8 | BOTANIJELLY ™ 105²/Vitamin E Acetate blend (9/1) |
| #9 | Castor wax MP 70¹/Castor Oil¹ blend (2/7) |
| #10 | Moringa butter⁷/phytantriol⁶ blend (1/9) |
| #11 | BIOESTOLIDE ™ 1300⁹ |

Note:
¹Castor wax mp-70, Hydrogenated castor oil, castor oil and trihydroxystearin from ACME-Hardesty.
²Hydrogenated vegetable glycerides from Cargill Company
³Jojoba ester from Floratech-A Cargill Company
⁴Polycitronellol (and) Euphorbia Cerifera (Candelilla) Wax from P2 Science Inc.
⁵Moringa oil from Naturex, part of Givaudan
⁶phytantriol from DSM
⁷Moringa butter from Hall
⁸Butyrospermum Parkii (Shea) Butter from BASF
⁹Acetyl Ethylhexylpolyhroxystearate

Jellies #4, #6, and #7 were commercially available and were not changed. Jelly #4, BOTANIJELLY™ 105, was an oligomer made by esterification and polymerization of natural oils. Jelly #6, FLORAESTER™ 30, was an interesterified form of Jojoba ester, with a melting point of about 47 to about 51° C. Jelly #7, CITROLATUM™ C, was a blend of Candelilla wax and a liquid polymer Polycitronellol with a repeating unit of about 2 to about 20. Jelly #11, BIOESTOLIDE™ 1300 was an oligomer synthesized by reacting 12-hydroxystearic acid and capped on both ends by acetic acid and ethylhexyl alcohol. The remaining jellies were prepared by combining the ingredients in a glass container and heating until molten in an 85° C. water bath, removing from the water bath and cooling to a room temperature of about 20 to about 25° C. In the jellies, where there was a mixture of materials, the ratio of one material to the other is given in the description in Table 1. For example, for Jelly #1, it is a blend of Castor wax MP 70 and soybean oil in a ratio of 2 to 7. Castor wax MP 70 is a partially hydrogenated castor oil, with a melting point of 68-72° C. Jelly #2 is a blend of CETIOL® SB 45 and a fully hydrogenated castor oil in a ratio of 8 to 1. CETIOL® SB 45 is shea butter with a melting point of 42-46° C. while the fully hydrogenated castor oil has a melting point of 86 to 88° C. Where a combination of materials is listed in Table 1, the ratio of materials is listed in parenthesis following the description. For example, in plant based jelly #1, castor wax and soybean oil blend were in a ratio of 2:7.

Separately, each jelly listed in Table 1 was combined with lauric acid in a ratio of 9 to 1 and heated until molten in an 85° C. water bath and then cooled to a room temperature of about 20 to about 25° C.

DSC Characterization of Plant-Based Jellies with and without Fatty Acid

In this step, plant-based jellies and plant-based jellies combined with a fatty acid were analyzed using DSC to determine their feasibility for use in nanoemulsions. The fatty acid when used was lauric acid and the plant-based jelly to fatty acid ratio was 9 to 1.

DSC analysis was performed to determine which plant-based jellies would be successful in a nanoemulsion composition by performing a heating and cooling cycle that heated from a temperature of −40° C. to 100° C. and then cooled from a temperature of 100° C. to −40° C. on a TA instrument DSC Q1000. The heating and cooling rate was 10° C. per minute. Data analysis was carried out with Universal Analysis 2000. Area under a specific peak and the peak temperature was determined using the function of integrate peak linear.

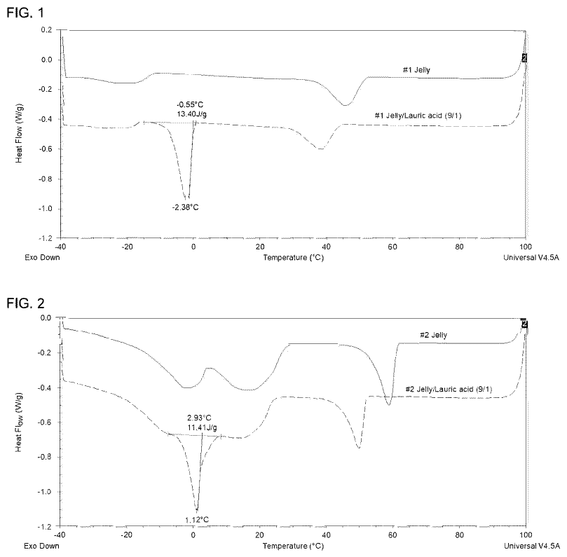

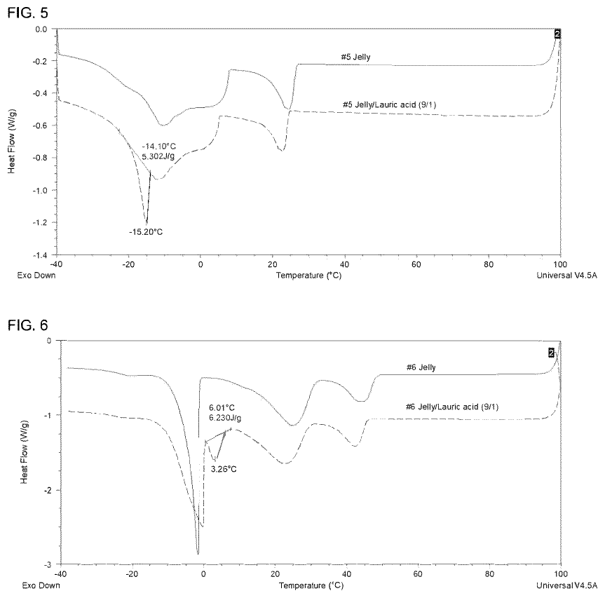

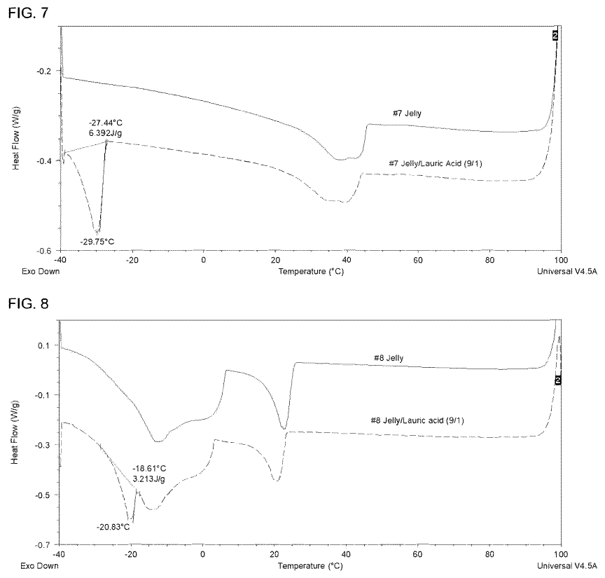

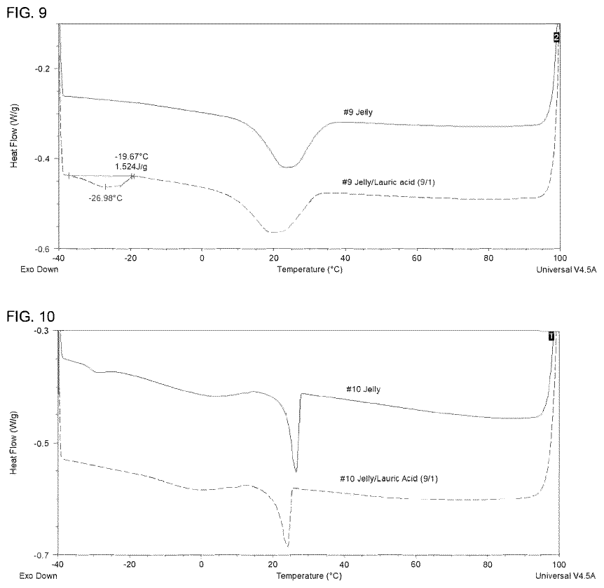

FIGS. 1 to 11 show the heat flow curve of plant-based jelly with (dashed line) and without lauric acid (solid line). With fatty acid included, there was an extra peak observed during the cooling process in the profile and its area and peak temperature can be obtained via the function of integrate peak linear using Universal Analysis 2000, shown in Table 2.

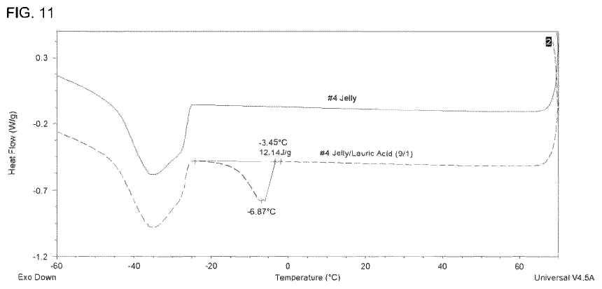

The peak area of the lauric acid induced peak for Jellies #1 to #11 ranged from 13.4 to 0 Joules per gram (J/g) while the peak temperature fell anywhere between −27° C. to 2° C. Jelly #1, a blend of Castor wax MP 70 and Soybean oil blend (2/7), yielded a peak area of 13.40 J/g and a peak temperature of −2.38° C., when in the presence of lauric acid in FIG. 1. Jelly #10, a blend of Moringa butter and phytantriol blend (1/9), did not generate any lauric acid induced peak as shown in FIG. 10.

TABLE 2
Natural Jelly Peak Area and Peak Temperature:

| | |
|---|---|
| | Lauric Acid Induced Peak @ |
| Natural | Plant-Based Jelly/Lauric Acid (9/1) |

| Jelly # | Peak Area, J/g | Peak Temperature, ° C. |
|---|---|---|
| #1 | 13.40 | −2.38 |
| #2 | 11.41 | 1.12 |
| #3 | 10.73 | 1.14 |
| #4 | 5.61 | −14.87 |
| #5 | 5.302 | −15.20 |
| #6 | 6.230 | 3.26 |
| #7 | 6.39 | −29.75 |
| #8 | 3.213 | −20.83 |
| #9 | 1.524 | −26.98 |
| #10 | 0 | Not Applicable |
| #11 | 12.14 | −6.87 |

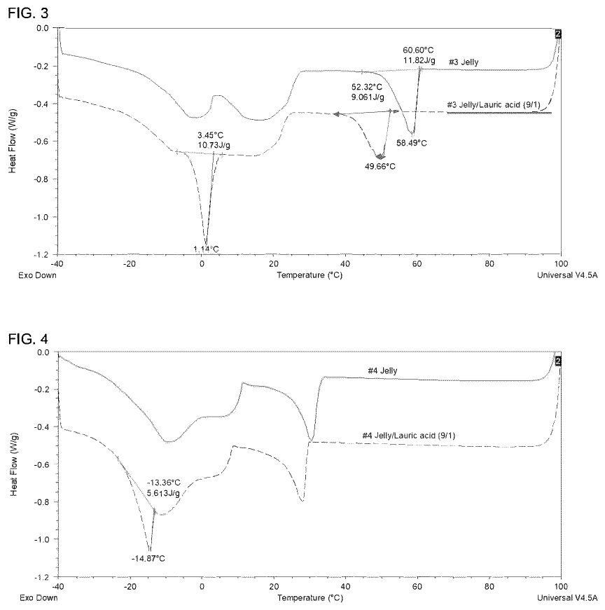

Inclusion of fatty acid into plant-based jellies decreased the freezing point of plant-based jellies as shown in FIG. 1 to 10. Jelly #3, for example, the onset of freezing point is shifted from 60.6° C. to 52.32° C. when lauric acid is present in FIG. 3. A decrease of 8.3° C. in the onset of the freezing point would reduce the processing temperature of Jelly #3 into the nanoemulsion by about 8° C., when lauric acid is mixed with Jelly #3.

### Nanoemulsion Examples and Comparatives

Nanoemulsions are typically formed in a two-stage process. The first stage was used to form a coarse emulsion. The internal oil phase and external aqueous phase were heated up to 75° C. (55° to 75° C.) separately such that each phase was clear and uniform (oil phase heated to 55 to 75° C. or until molten); then the internal oil phase was mixed with the external aqueous phase with intensive mixing. Intensive mixing can be accomplished via conventional means including mixing the materials in a stirred tank and passing the mixture through a rotor/stator mixer such as the Silverson® high shear in-line mixer or mixing them in the vessel with a high shear mixer such as the Scott® Turban mixer. Alternatively, the coarse emulsion may be created by using a continuous high shear mixing device such as the standard Sonolator device produced by Sonic Corporation of Connecticut. These standard sonolators are normally operated at pressures of 200-500 psi (1.4 to 3.4 MPa) to form a coarse emulsion.

The second stage of the process was to pass the coarse emulsion through a high pressure homogenizer to form the nanoemulsion at a pressure of 1500 to 5000 psi (10.3 to 34.4 MPa) to achieve a desired droplet size of 75 to 350 nm, in terms of volume average diameter, D[4,3], measured by a Malvern Mastersizer 3000. High pressure homogenizers used were the Nano DeBee homogenizer of BEE International (Massachusetts, USA) and the High Pressure Sonolator device also produced by Sonic Corporation of Connecticut, USA. These devices can be operated up to 1000-5000 psi (6.9 to 34.4 MPa) in order to produce nanoemulsions with droplet sizes in terms of volume average diameter (D[4,3]) of less than 400 nm. Homogenizers from other suppliers can be used as long as they can be operated at pressures of 1000-5000 psi (6.9 to 34.4 MPa).

TABLE 3
Nanoemulsion Examples 1-9 and Comparative Examples 1-2

| | Ex. 1 | Ex. 2 | Ex. 3 | Ex. 4 | Ex. 5 | Ex. 6 | Ex. 7 | Ex. 8 | Ex. 9 | Comp. 1 | Comp. 2 |
|---|---|---|---|---|---|---|---|---|---|---|---|
| Ingredients | Weight % | | | | | | | | | | |
| Lauric acid | 6 | 6 | 6 | | | | | | 3 | 6 | |
| Jelly #1 | 54 | | | | | | | | | | |
| Jelly #2 | | 54 | | | | | | | | | |
| Jelly #3 | | | 54 | | | | | | | | |
| Jelly #4 | | | | 60 | | | | | | | |
| Jelly #5 | | | | | 60 | | | | | | |
| Jelly #6 | | | | | | 60 | | | | | |
| Jelly #7 | | | | | | | 60 | | | | |
| Jelly #8 | | | | | | | | 60 | | | |
| Jelly #9 | | | | | | | | | | 54 | |
| Jelly #10 | | | | | | | | | | | 60 |
| Jelly #11 | | | | | | | | | 60 | | |

| | |
|---|---|
| DI Water | q.s. |
| Pureact SLI-2 | 6.6 |
| Flake¹ | |
| Galsoft SLT | 2.2 |
| (N)² | |
| Preservatives | Less than 1 |
| Sodium | To adjust pH to 5 to 7 |
| hydroxide | |

Note:
¹from Innospec, INCI Name: Sodium Lauroyl Isethionate, with 78-82% active and 8-13% free fatty acid, mainly lauric acid.
²from Galaxy Surfactants, Ltd, INCI Name: Sodium Methyl Lauroyl Taurate, with 84-88% active and free fatty acid less than 4.5%.

TABLE 4
Corelations of lauric acid induced peak area and feasibility
of forming stable nanoemulsions of Natural Jellies:

| | Lauric Acid Induced Peak @ | | Plant-based Jelly |
|---|---|---|---|
| Natural | Jelly/Lauric Acid (9/1) | | to form stable |
| Jelly # | Peak Area, J/g | Peak Temperature, ° C. | Nanoemulsion? |
| #1 | 13.40 | −2.38 | Yes |
| #2 | 11.41 | 1.12 | Yes |
| #3 | 10.73 | 1.14 | Yes |
| #4 | 5.61 | −14.87 | Yes |
| #5 | 5.302 | −15.20 | Yes |
| #6 | 6.230 | 3.26 | Yes |
| #7 | 6.39 | −29.75 | Yes |
| #8 | 3.213 | −20.83 | Yes |
| #9 | 1.524 | −26.98 | No |
| #10 | 0 | Not Applicable | No |
| #11 | 12.14 | −6.87 | Yes |

As can be seen from the results in Table 4, when the peak area was greater than 2.5 J/g, a stable nanoemulsion was able to be formed from the plant-based jelly. Such nanoemulsions could not be formed when the peak was less than 2.5 J/g, as demonstrated by the nanoemulsion examples and comparatives listed in Table 3.

1. A method of classifying plant-based jelly for nanoemulsions, comprising:
providing a plant-based jelly;
combining the plant-based jelly with a C₈ to C₁₈, to form a mixture, wherein the plant-based jelly and fatty acid are in a ratio of 30:1 to 2:1;
heating the mixture until it reaches a molten state or to a temperature less than or equal to 85° C.;
cooling the mixture to room temperature;
subjecting the mixture to a heating and cooling cycle, wherein the heating and cooling cycle comprises heating wherein the heating and cooling cycle comprises heating from a temperature range of −80° C. to −40° C. to a temperature range of 80° C. to 120° C. and then cooling from a temperature of 80° C. to 120° C. to a temperature range of −80° C. to −40° C., wherein the heating and cooling rate is 1° C. per minute to 15° C. per minute;
analyzing the mixture with a differential scanning calorimeter; and
selecting the plant-based jelly for the nanoemulsion if the area under the fatty acid induced peak on the cooling profile is greater than 2.5 Joules/gram.

2. A method of making a nanoemulsion, comprising:
providing a plant-based jelly combined with a C₈ to C₁₈, to form a mixture, wherein the plant-based jelly and fatty acid are in a ratio of 30:1 to 2:1;
classifying the plant-based jelly and fatty acid mixture according to the method of claim 1, wherein if the area under the fatty acid induced peak on the cooling profile is greater than 2.5 Joules/gram, then the plant-based jelly and fatty acid mixture is selected to form the nanoemulsion;
heating an internal oil phase comprising the plant-based jelly to a temperature of greater than or equal to 55° C.;
heating an external aqueous phase comprising water and a surfactant mixture to a temperature of greater than or equal to 55° C.;
combining the internal oil phase and the external aqueous phase, forming a first emulsion; and
passing the first emulsion through a device at a pressure of greater than or equal to 1000 psi (6.9 MPa), forming the nanoemulsion.

3. The method of claim 1, wherein the size of area under the peak is greater than or equal to 3.0 Joules/gram.

4. The method of claim 1, wherein the plant-based jelly comprises hydrogenated plant-based oils with a melting point of 20 to 80° C., blends of plant-based liquid oil and naturally derived wax, plant-based butter, oligomers synthesized from plant-based compositions, or a combination thereof.

5. The method of claim 4, wherein the hydrogenated plant-based oils with a melting point of 20 to 80° C. comprise fully hydrogenated oils with all double bonds saturated and partially hydrogenated oils with less than 100% of double bonds being saturated, via addition of hydrogen to the double bonds.

6. The method of claim 5, wherein the blends of plant-based liquid oil and naturally derived wax comprise (a) 25-95% by wt. of a pre-blended mixture composition of naturally derived liquid oils comprising (1) squalane; (2) mono-esters; (3) triglycerides, or (4) a combination thereof; wherein said liquid oils have a melting or phase transition point of less than 30° C. and a viscosity of 500 Pa·s or less at room temperature; and (b) 5 to 75% by wt. of a pre-blended mixture composition of a naturally derived structuring material comprising of naturally derived plant and vegetable waxes; wherein said structuring material has melting point of greater than 30° C.

7. The method of claim 4, wherein the plant-based butter comprises shea butter, mango seed butter, olive butter, almond butter, cocoa butter, coconut butter, macadamia butter, kokum butter, babassu butter, moringa butter, Jojoba butter, sunflower seed butter, or a combination thereof.

8. The method of claim 7, wherein the oligomers synthesized from plant-based compositions comprise polycitronellol and polycitronelloe acetate; hydrogenated soy polyglycerides; a C12-C18 Alkanoyl Glycerin/Sebacic Acid Copolymer; acetyl ethylhexylpolyhydroxystearate; Diisostearyl Dimer Dilinoleate, or a combination thereof.

9. The method of claim 1, wherein the fatty acid comprises lauric acid, myristic acid, palmitic acid, stearic acid, coconut fatty acid, or a combination thereof.

10. A nanoemulsion composition, made by the process of claim 2, wherein the nanoemulsion composition comprises:
an internal oil phase, comprising:
40 to 75% by weight of the total nanoemulsion composition of a plant-based jelly comprising hydrogenated plant-based oil having a melting point of 20 to 80° C., blends of plant-based liquid oil and naturally derived wax, oligomers synthesized from plant-based compositions, or a combination thereof; and
optionally a C₈ to C₁₈, wherein, when the fatty acid is present, the plant-based jelly and fatty acid are present in a ratio of 120:1 to 2:1
wherein the blends of plant-based liquid oil and naturally derived wax comprise (a) 25-95% by wt. of a pre-blended mixture composition of naturally derived liquid oils comprising (1) squalene or other plant derived C15-23 alkanes; (2) mono-esters; (3) triglycerides or (4) a combination thereof; wherein said liquid oils have a melting or phase transition point of less than 30° C. and a viscosity of 500 Pa·s or less at room temperature; and (b) 5 to 75% by wt. of a pre-blended mixture composition of a naturally derived structuring material comprising of naturally derived plant and vegetable waxes; wherein said structuring material has a melting point of greater than 30° C.; and
an external aqueous phase, comprising:
water; and
1.6 to 15% by weight of the total nanoemulsion composition of a surfactant or surfactants comprising an alkali metal, an ammonium salt of acyl isethionate, an alkali metal C1 to C3 alkyl acyl taurate, an acyl taurate, a zwitterionic surfactant, an amphoteric surfactant, or a combination thereof;
wherein the surfactant or surfactants comprising an alkali metal, an ammonium salt of acyl isethionate, an alkali metal C1 to C3 alkyl alkyl taurate, an acyl taurate, or a combination thereof comprises equal to 70% or greater of all surfactants present in the external aqueous phase of the nanoemulsion.

11. The nanoemulsion of claim 11, comprising 0.33% to 8.33% fatty acid.

12. (canceled)

13. (canceled)

14. (canceled)

15. The nanoemulsion of claim 10, wherein the oligomers synthesized from plant-based compositions comprise polycitronellol and polycitronelloe acetate; hydrogenated soy polyglycerides; a C12-C18 Alkanoyl Glycerin/Sebacic Acid Copolymer; acetyl ethylhexylpolyhydroxystearate; Diisostearyl Dimer Dilinoleate, or a combination thereof.

16. The method of claim 1, wherein the area under the fatty acid induced peak on the cooling profile is greater than or equal to 2.75 Joules/gram.

17. The method of claim 2, wherein the plant-based jelly and fatty acid are in a ratio of 10:1 to 2:1.

18. The method of claim 5, wherein the oils comprise soybean oil, sunflower seed oil, palm oil, olive oil, canola oil, jatropha oil, argan oil, castor oil, partially or fully hydrogenated mono-ester oil, or a combination thereof.

19. The method of claim 9, wherein the fatty acid is lauric acid.
